(19) United States
(12) Patent Application Publication
(10) Pub. No.: US 2025/0142253 A1
(43) Pub. Date: May 1, 2025

(54) OVERAMPLITUDE PREVENTION APPARATUS OF SPEAKER

(71) Applicant: ALPS ALPINE CO., LTD., Tokyo (JP)

(72) Inventor: Yuji SAITO, Fukushima (JP)

(21) Appl. No.: 18/927,351

(22) Filed: Oct. 25, 2024

(30) Foreign Application Priority Data
Oct. 30, 2023 (JP) 2023-185338

(51) Int. Cl. H04R 3/00

(52) U.S. Cl. CPC H04R 3/007; H04R 2430/01

(57) ABSTRACT

An overamplitude prevention apparatus of a speaker prevents overamplitude of a vibration system of the speaker with respect to an input signal. The overamplitude prevention apparatus includes a displacement detector that detects a displacement of the vibration system; and an amplitude controller to which the input signal is input. The amplitude controller includes a gain adjuster that adjusts the input signal by a set gain and outputs the input signal to the speaker; a displacement predictor that predicts the displacement based on the input signal; a predicted displacement corrector that corrects the predicted displacement; and a gain setter that sets, in the gain adjuster, the gain for attenuating the corrected displacement to a displacement not exceeding a predetermined displacement width. The predicted displacement corrector calculates a difference between the predicted displacement with the detected displacement corresponding to the input signal, and corrects the predicted displacement according to the difference.

### CROSS-REFERENCE TO RELATED APPLICATIONS

The present application is based on and claims priority to Japanese Patent Application No. 2023-185338, filed on Oct. 30, 2023, the entire contents of which are incorporated herein by reference.

### BACKGROUND OF THE INVENTION

### 1. Field of the Invention

The present invention relates to a technology for preventing overamplitude of a vibration system of a speaker.

### 2. Description of the Related Art

A speaker vibrates by passively displacing a vibration system according to the magnitude of an input signal, and, therefore, overamplitude occurs when the input signal becomes excessive, and speaker abnormalities occur, such as the voice coil bobbin of the speaker hitting the bottom or a failure in which the displacement of the elastic body reaches a fracture region and the vibration system member is damaged.

As a technique for preventing the occurrence of such overamplitude of the vibration system of the speaker, there is known a technique for calculating a predicted value of the displacement of the vibration system of the speaker according to the input signal based on the equivalent circuit of the speaker, and performing amplitude control on the input signal when the predicted value is greater than a predetermined threshold value (for example, Patent Documents 1, 2).

Further, as a technique related to the present application, there is known a technique for detecting the actual displacement of the vibration system of the speaker by using a sensor, and a technique for detecting the input voltage and input current of the actual speaker and the displacement of the vibration system, and updating each characteristic of the equivalent circuit of the speaker to a characteristic consistent with the actual speaker based on the detected value (for example, Patent Document 3).

### RELATED-ART DOCUMENTS

### Patent Documents

Patent Document 1: WO 2018/116861
Patent Document 2: Japanese Unexamined Patent Application Publication No. 2013-55676
Patent Document 3: Japanese Unexamined Patent Application Publication No. 2022-143855

According to the above-described technique for performing amplitude control based on the predicted value of the displacement of the vibration system of the speaker based on the equivalent circuit of the speaker, the displacement of the speaker may not be accurately predicted due to the degree of reproducibility of the equivalent circuit, variations in individual speakers, and changes in characteristics of each speaker with time.

Therefore, it is necessary to perform amplitude control with a margin for the target amplitude range, and as a result, the performance of the speaker cannot be fully exhibited.

### SUMMARY OF THE INVENTION

It is therefore a general object of the present invention to more accurately control the amplitude of the vibration system of the speaker to the target amplitude range.

According to an embodiment, there is provided an overamplitude prevention apparatus of a speaker for preventing overamplitude of a vibration system of the speaker with respect to an input signal, the overamplitude prevention apparatus including:
a displacement detector configured to detect a displacement of the vibration system of the speaker; and
an amplitude controller to which the input signal is input, wherein
the amplitude controller includes:
   a gain adjuster configured to adjust the input signal by a set gain and output the input signal to the speaker;
   a displacement predictor configured to predict the displacement of the vibration system of the speaker based on the input signal;
   a predicted displacement corrector configured to correct the displacement predicted by the displacement predictor; and
   a gain setter configured to set the gain in the gain adjuster, the gain being for attenuating the displacement corrected by the predicted displacement corrector to a displacement not exceeding a predetermined displacement width, wherein
the predicted displacement corrector calculates a difference of the displacement predicted by the displacement predictor in the past with respect to the displacement detected by the displacement detector corresponding to the input signal used for predicting the displacement, and corrects the displacement predicted by the displacement predictor by an amount according to the calculated difference.

### BRIEF DESCRIPTION OF THE DRAWINGS

Other objects and further features of the present invention will be apparent from the following detailed description when read in conjunction with the accompanying drawings, in which:

FIG. 1 is a diagram illustrating the configuration of an acoustic system according to a first embodiment of the present invention;

FIGS. 2A and 2B are diagrams illustrating the configuration of displacement detection according to a first embodiment of the present invention;

FIG. 3 is a diagram illustrating the configuration of an attenuator gain control unit according to a first embodiment of the present invention;

FIG. 4 is a diagram illustrating an equivalent circuit of a speaker used in a first embodiment of the present invention;

FIG. 5 is a flowchart illustrating a speaker displacement error calibration process according to a first embodiment of the present invention;

FIG. 6 is a diagram illustrating an example of amplitude control according to a first embodiment of the present invention;

FIG. 7 is a diagram illustrating a configuration of an attenuator gain control unit according to a second embodiment of the present invention;

FIG. 8 is a diagram illustrating a configuration of an attenuator gain control unit according to a third embodiment of the present invention;

FIG. 9 is a diagram illustrating a configuration of an amplitude control unit according to a fourth embodiment of the present invention; and

FIG. 10 illustrates a configuration of an amplitude control unit according to a fifth embodiment of the present invention.

### DESCRIPTION OF THE EMBODIMENTS

For achieving the above object, an embodiment of the present invention is an overamplitude prevention apparatus of a speaker for preventing overamplitude of a vibration system of the speaker with respect to an input signal, the overamplitude prevention apparatus including:
a displacement detector configured to detect a displacement of the vibration system of the speaker; and
an amplitude controller to which the input signal is input.

The amplitude controller includes:
a gain adjuster configured to adjust the input signal by a set gain and output the input signal to the speaker;
a displacement predictor configured to predict the displacement of the vibration system of the speaker based on the input signal;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width.

The predicted displacement corrector calculates a difference of the displacement predicted by the displacement predictor in the past with respect to the displacement detected by the displacement detector corresponding to the input signal used for predicting the displacement, and corrects the displacement predicted by the displacement predictor by an amount according to the calculated difference.

Further, for achieving the above object, an embodiment of the present invention is an overamplitude prevention apparatus of a speaker for preventing overamplitude of a vibration system of the speaker with respect to an input signal, the overamplitude prevention apparatus including:
a displacement detector configured to detect a displacement of the vibration system of the speaker;
a band divider configured to divide the input signal into input signals of respective bands;
an amplitude controller to which the input signal is input, the input signal being of a corresponding band obtained by the division by the band divider, the amplitude controller being provided corresponding to each of the bands; and
a mixer.

Each of the amplitude controllers includes:
a gain adjuster configured to adjust the input signal of the corresponding band by a set gain and output the input signal to the mixer;
a displacement predictor configured to predict the displacement of the vibration system of the speaker based on the input signal of the corresponding band;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width.

The predicted displacement corrector calculates a difference between the displacement predicted by the displacement predictor in the past and a component of the corresponding band of the displacement detected by the displacement detector corresponding to the input signal of the corresponding band used for predicting the displacement, and corrects the displacement predicted by the displacement predictor by an amount according to the calculated difference.

The mixer combines the input signals of the respective bands output from the gain adjuster of each of the amplitude controllers, and outputs the combined signal to the speaker.

Further, for achieving the above object, an embodiment of the present invention is an overamplitude prevention apparatus of a speaker for preventing overamplitude of a vibration system of the speaker with respect to an input signal, the overamplitude prevention apparatus including:
a displacement detector configured to detect a displacement of the vibration system of the speaker;
a band divider configured to divide the input signal into an input signal of a low-frequency side and an input signal of a high-frequency side;
an amplitude controller to which the input signal is input, the input signal being of the low-frequency side obtained by the division by the band divider; and
a mixer.

The amplitude controller includes:
a gain adjuster configured to adjust the input signal of the low-frequency side by a set gain and output the input signal to the mixer;
a displacement predictor configured to predict the displacement of the vibration system of the speaker based on the input signal of the low-frequency side;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width.

The predicted displacement corrector calculates a difference between the displacement predicted by the displacement predictor in the past and a component of the low-frequency side of the displacement detected by the displacement detector corresponding to the input signal of the low-frequency side used for predicting the displacement, and corrects the displacement predicted by the displacement predictor by an amount according to the calculated difference.

The mixer combines the input signal of the low-frequency side output from the gain adjuster of the amplitude controller with the input signal of the high-frequency side obtained by the division by the band divider, and outputs the combined signal to the speaker.

In the above overamplitude prevention apparatus of the speaker, the predicted displacement corrector may be configured to correct the displacement predicted by the displacement predictor by a maximum value of the difference calculated until a current time.

Further, in the above overamplitude prevention apparatus of the speaker, the gain setter may be configured to set, to the gain adjuster, a gain for attenuating the displacement corrected by the predicted displacement corrector to a displacement not exceeding a predetermined displacement width, when the gain for attenuating the displacement to the displacement not exceeding the displacement width is smaller than the gain currently set in the gain adjuster.

Further, the above overamplitude prevention apparatus of the speaker may further include:
an input detector configured to detect an input of the speaker; and
a speaker equivalent circuit updater, wherein
the displacement predictor may predict the displacement of the vibration system of the speaker according to an equivalent circuit of the speaker set in the displacement predictor, and
the speaker equivalent circuit updater may update a characteristic of the equivalent circuit set in the displacement predictor so as to be consistent with a relationship between the input of the speaker detected by the input detector and the displacement detected with respect to the input by the displacement detector.

According to the speaker overamplitude prevention apparatus described above, the error of the displacement predicted at a current time is estimated based on the result of the difference between the displacement predicted by the displacement predictor from the input signal in the past and the displacement actually detected with respect to the input signal by the displacement detector, the predicted displacement is corrected by the error, and the amplitude control based on the corrected displacement is performed, so that the amplitude of the speaker vibration system can be more accurately controlled to be within a target amplitude range than when the amplitude control is performed based only on the displacement predicted by the displacement predictor.

Further, for achieving the above object, an embodiment of the present invention is an overamplitude prevention apparatus of a speaker for preventing overamplitude of a vibration system of the speaker with respect to an input signal, the overamplitude prevention apparatus including:
a displacement detector configured to detect a displacement of the vibration system of the speaker;
an input detector configured to detect an input of the speaker; and
an amplitude controller to which the input signal is input.

The amplitude controller includes:
a gain adjuster configured to adjust the input signal by a set gain and output the input signal to the speaker;
a displacement predictor configured to predict the displacement of the vibration system of the speaker based on the input signal according to an equivalent circuit of the speaker set in the displacement predictor;
a gain setter configured to set the gain in the gain adjuster, the gain being for attenuating the displacement to a displacement not exceeding a predetermined displacement width; and
a speaker equivalent circuit updater configured to update a characteristic of the equivalent circuit set in the displacement predictor so as to be consistent with a relationship between the input of the speaker detected by the input detector and the displacement detected with respect to the input by the displacement detector.

According to the overamplitude prevention apparatus of the speaker, the characteristics of the equivalent circuit used by the displacement predictor for predicting the displacement of the vibration system can be updated at any time by using the actual displacement of the vibration system of the speaker detected by the displacement detector so as to be consistent with the actual characteristics of the speaker. As a result, the accuracy of the prediction of the displacement can be improved and the amplitude of the vibration system of the speaker can be more accurately controlled to be within the target amplitude range, than in the case where the characteristics of the equivalent circuit using the actual displacement of the vibration system of the speaker are not updated.

According to the present invention, the amplitude of the vibration system of the speaker can be more accurately controlled to be within the target amplitude range.

A first embodiment of the present invention will be described below.

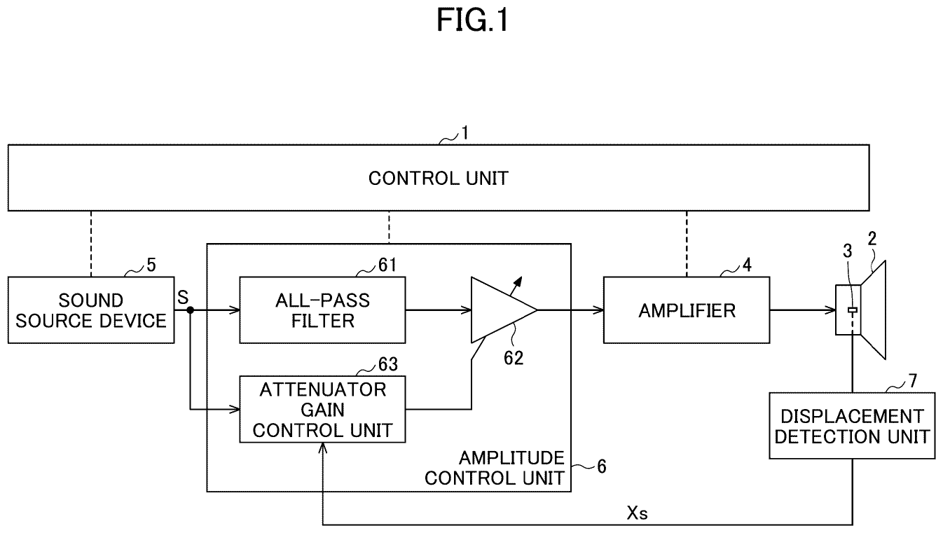

FIG. 1 illustrates a configuration of an acoustic system according to a first embodiment.

As illustrated in the figure, the acoustic system includes a control unit 1, a speaker 2, a sensor 3 provided in the speaker 2, an amplifier 4, a sound source device 5 for outputting a sound source output signal S which is an audio signal, an amplitude control unit 6, and a displacement detection unit 7 for measuring the displacement Xs of the vibration system of the speaker 2 from the output of the sensor 3.

The amplitude control unit 6 adjusts the gain of the sound source output signal, which is an audio signal output from the sound source device 5, and outputs the signal to the amplifier 4 as an intermediate output signal. The amplifier 4 amplifies the intermediate output signal at a predetermined gain to generate an amplifier output signal, and drives the speaker 2 by the amplifier output signal.

Further, the control unit 1 receives input of information from the sound source device 5, such as a replay state of a song being played or a song not being played, information about the audio content being played, an output level (volume, etc.), and the like.

Next, the amplitude control unit 6 includes an all-pass filter 61, an attenuator 62, and an attenuator gain control unit 63.

The all-pass filter 61 outputs to the attenuator 62 an audio signal obtained by delaying the sound source output signal S output from the sound source device 5 by a predetermined delay time. This delay time will be described later.

The attenuator gain control unit 63 calculates and sets the gain of the attenuator 62 from the displacement Xs of the vibration system of the speaker 2 detected by the displacement detection unit 7 and the sound source output signal S output from the sound source device 5. Details of the attenuator gain control unit 63 will be described later.

The attenuator 62 adjusts the level of the audio signal output by the all-pass filter 61 with the gain set by the attenuator gain control unit 63, and outputs the signal to the amplifier 4 as an intermediate output signal.

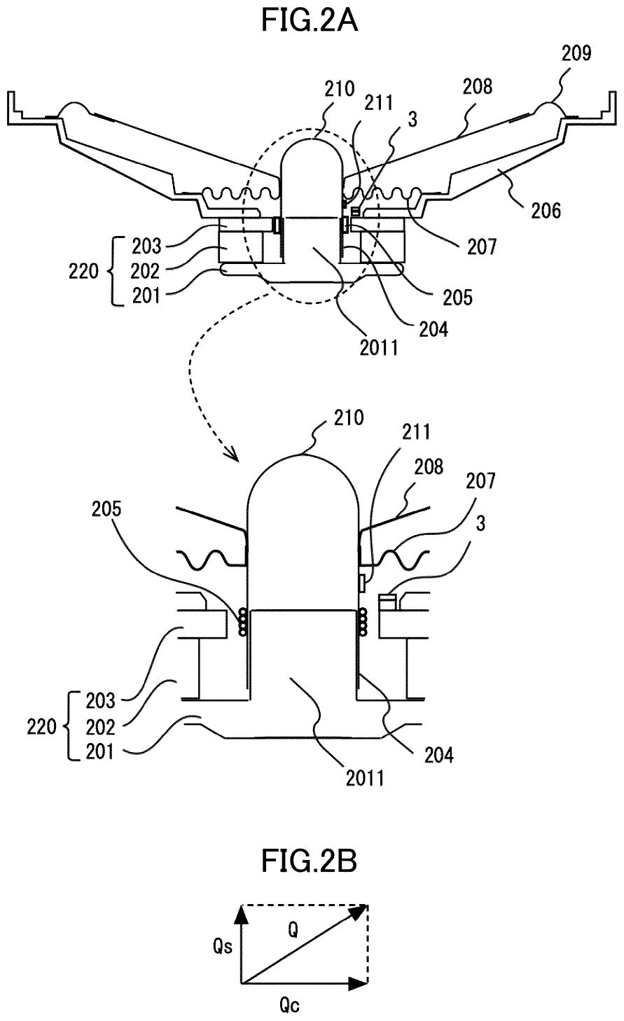

Next, FIG. 2A illustrates the configuration of the speaker 2.

As illustrated in FIG. 2A, the speaker 2 includes a yoke 201, a magnet 202, a top plate 203, a voice coil bobbin 204, a voice coil 205, a frame 206, a damper 207, a diaphragm 208, an edge 209, a dust cap 210, and a displacement detection magnet 211.

Here, by viewing the upper portion of the figure as the front of the speaker and the bottom portion of the figure as the rear of the speaker, the yoke 201 has a protrusion 2011 protruding forward at the center thereof, an annular magnet 202 is provided on the outer periphery of the protrusion 2011, and an annular top plate 203 is provided on the magnet 202. The top plate 203 is composed of a conductive member such as iron. A magnetic circuit 220 is formed of the yoke 201, the magnet 202, and the top plate 203.

The voice coil bobbin 204 has a hollow cylindrical shape, and a voice coil 205 to which a signal from the amplifier 4 is applied is wound around the outer periphery. The protrusion 2011 of the yoke 201 is inserted into the hollow portion of the voice coil bobbin 204 from behind so that the voice coil bobbin 204 can move back and forth with respect to the yoke 201, and the voice coil 205 is arranged at a position between the protrusion 2011 of the yoke 201 and the top plate 203 where a magnetic flux generated between the inner peripheral ends of the top plate 203 by the magnetic circuit 220 passes.

The diaphragm 208 has a shape roughly similar to that of the side face of a conical frustum in which the longitudinal direction of the speaker 2 is the height direction, and the outer peripheral end of the diaphragm 208 is connected to the front end of the frame 206 by an edge 209. The inner peripheral end of the diaphragm 208 is fixed to the front end of the voice coil bobbin 204.

In such a configuration of the speaker 2, when an output signal from the amplifier 4 is applied to the voice coil 205, the voice coil bobbin 204 vibrates back and forth according to the amplitude of the output signal by the electromagnetic action between the magnetic flux generated from the magnetic circuit 220 and the signal flowing through the voice coil 205. When the voice coil bobbin 204 vibrates, the diaphragm 208 connected to the voice coil bobbin 204 vibrates, and a sound corresponding to the signal from the amplifier 4 is generated.

The displacement detection magnet 211 is fixed to the outer peripheral side of the voice coil bobbin 204 so as to move up and down together with the voice coil bobbin 204, and generates a magnetic flux in a direction orthogonal to the magnetic flux generated by the magnetic circuit 220.

Here, the sensor 3 described above is fixed at a position of the non-vibrating system of the speaker 2, such as the top plate 203, close to the displacement detection magnet. As illustrated in FIG. 2B, the sensor 3 is a magnetic angle sensor, and detects and outputs, as a magnetic angle, the arctangent Qs/Qc of the angle of the combined vector Q of the magnetic flux vector Qc acting from the magnetic circuit 220 and the magnetic flux vector Qs acting from the displacement detection magnet 211. The magnetic flux vector generated by the displacement detection magnet acting on the sensor 3 changes according to the displacement of the displacement detection magnet 211 accompanying the displacement of the voice coil bobbin 204, and, therefore, the magnetic angle becomes a value according to the displacement amount of the voice coil bobbin 204.

Then, as illustrated in FIG. 1, the displacement detection unit 7 measures the displacement of the vibrating system of the speaker 2 from the output of the sensor 3, and outputs the displacement to the attenuator gain control unit 63 as the displacement Xs.

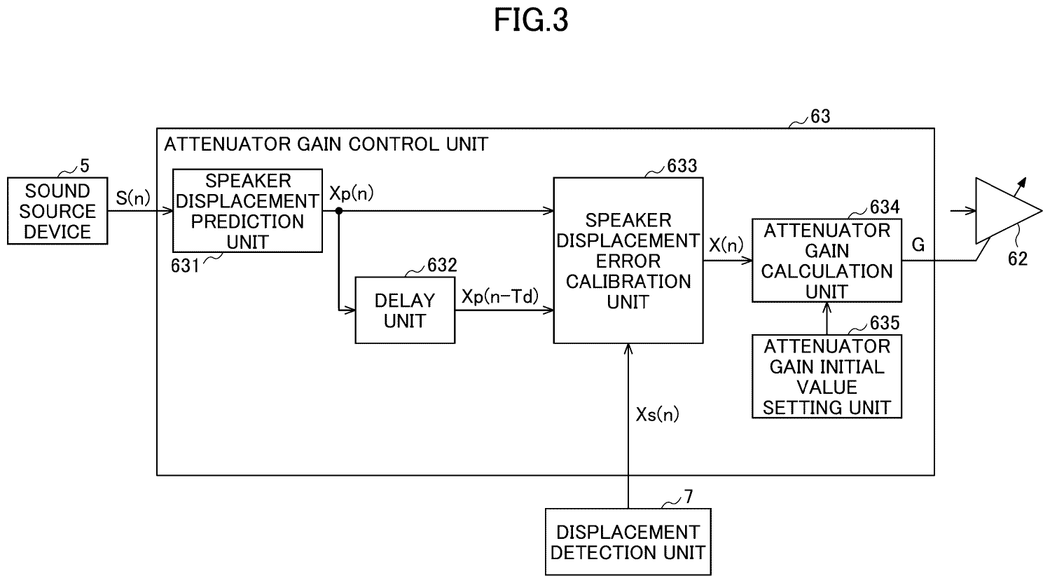

Next, FIG. 3 illustrates the configuration of the attenuator gain control unit 63 of the amplitude control unit 6.

As illustrated in FIG. 3, the attenuator gain control unit 63 includes a speaker displacement prediction unit 631, a delay unit 632, a speaker displacement error calibration unit 633, an attenuator gain calculation unit 634, and an attenuator gain initial value setting unit 635.

The speaker displacement prediction unit 631 predicts the displacement of the vibrating system of the speaker 2 based on the sound source output signal S (n) output from the sound source device 5 according to a preset equivalent circuit (speaker model) of the speaker 2, and outputs the displacement as the predicted displacement Xp(n).

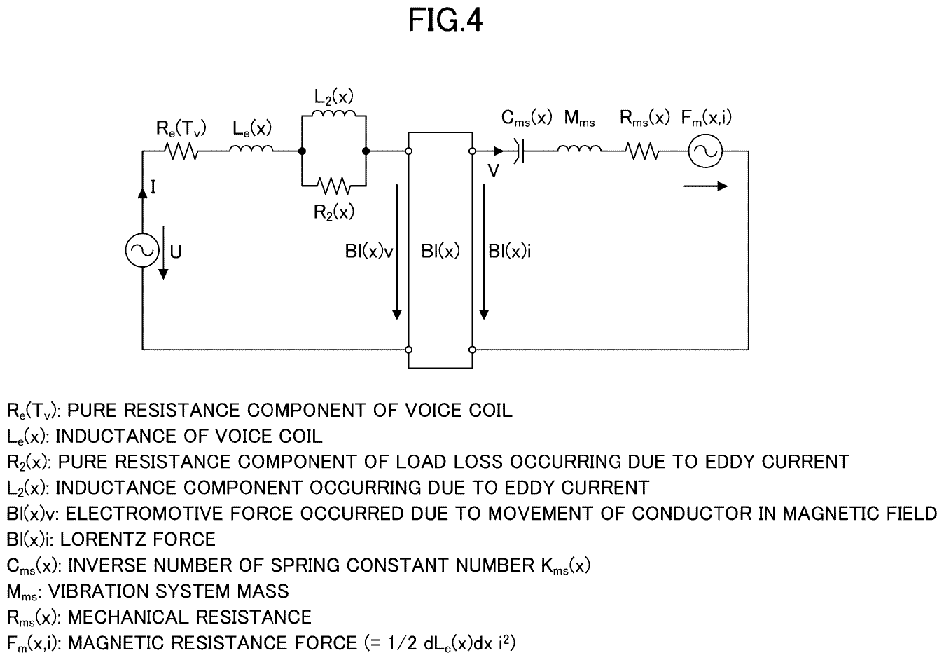

As the equivalent circuit of the speaker 2, for example, the equivalent circuit illustrated in FIG. 4 can be used.

When the equivalent circuit illustrated in FIG. 4 is used, the predicted displacement Xp(n) can be obtained by the following equation (1).

$$Xp ( n ) = - {a}_{1} Xp ( n - 1 ) - {a}_{2} Xp ( n - 2 ) - {a}_{3} X p ( n - 3 ) + \{ {b}_{0} S ( n ) + {b}_{1} S ( n - 1 ) + {b}_{2} S ( n - 2 ) + {b}_{3} S ( n - 3 ) \} A \qquad Equation ( 1 )$$

$${a}_{0} = {R}_{e} {K}_{m s} + 2 {F}_{s} ( {R}_{e} {R}_{m s} + {L}_{e} {K}_{m s} + B {1}^{2} ) + 4 {F}_{s}^{2} ( {R}_{e} {M}_{m s} + {L}_{e} {R}_{m s} ) + 8 {F}_{s}^{3} ( {M}_{m s} {L}_{e} )$$

$${a}_{1} = \{ 3 {R}_{e} {K}_{m s} + 2 {F}_{s} ( {R}_{e} {R}_{m s} + {L}_{e} {K}_{m s} + B {1}^{2} ) 4 {F}_{s}^{2} ( {R}_{e} {M}_{m s} + {L}_{e} {R}_{m s} ) 24 {F}_{s}^{3} ( {M}_{m s} {L}_{e} ) \} / {a}_{0}$$

$${a}_{2} = \{ 3 {R}_{e} {K}_{m s} 2 {F}_{s} ( {R}_{e} {R}_{m s} + {L}_{e} {K}_{m s} + B {1}^{2} ) 4 {F}_{s}^{2} ( {R}_{e} {M}_{m s} + {L}_{e} {R}_{m s} ) + 24 {F}_{s}^{3} ( {M}_{m s} {L}_{e} ) \} / {a}_{0}$$

$${a}_{3} = \{ {R}_{e} {K}_{m s} 2 {F}_{s} ( {R}_{e} {R}_{m s} + {L}_{e} {K}_{m s} + B {1}^{2} ) + 4 {F}_{s}^{2} ( {R}_{e} {M}_{m s} + {L}_{e} {R}_{m s} ) 8 {F}_{s}^{3} ( {M}_{m s} {L}_{e} ) \} / {a}_{0}$$

$${b}_{0} = B 1 / {a}_{0}$$

$${b}_{1} = 3 B 1 / {a}_{0}$$

$${b}_{2} = 3 B 1 / {a}_{0}$$

$${b}_{3} = B 1 / {a}_{0}$$

Here, A is the gain of the amplifier 4, Xp is time series data, and Xp (i) represents the i-th data of the predicted displacement Xp. Further, S is time series data, and S (i) represents the i-th data of the sound source output signal S. Further, Fₛ is the sampling frequency of these pieces of time series data.

Here, as for the value of the gain A of the amplifier 4, if the value is known from a set value or a design value, that value is used.

If the value of the gain A of the amplifier 4 is not known, the gain A can be obtained as follows, for example.

That is, immediately after the start of the acoustic system or the like, a test signal having a frequency (for example, 20 Hz) close to the non-audible range within the range in which the sensor 3 can detect the displacement, is output from the sound source device 5 as a sound source output signal S (n), and the gain A can be obtained by solving the following equation (2) by using the displacement Xs detected by the displacement detection unit 7.

$$Xs ( n ) = - {a}_{1} X s ( n - 1 ) - {a}_{2} X s ( n - 2 ) - {a}_{3} X s ( n - 3 ) + \{ {b}_{0} S ( n ) + {b}_{1} S ( n - 1 ) + {b}_{2} S ( n - 2 ) + {b}_{3} S ( n - 3 ) \} A \qquad Equation ( 2 )$$

Note that Xs is time series data, and Xs (i) represents the i-th data of the displacement Xs.

Here, the speaker displacement prediction unit 631 may calculate the predicted displacement Xp(n) by using an equivalent circuit different from that illustrated in FIG. 4.

Alternatively, the speaker displacement prediction unit 631 may set in advance the correspondence between the sound source output signal S and the displacement Xp, and calculate the predicted displacement Xp(n) according to the correspondence set in the speaker displacement prediction unit 631.

Referring back to FIG. 3, the predicted displacement Xp(n) calculated by the speaker displacement prediction unit 631 is output to the speaker displacement error calibration unit 633 and the delay unit 632.

The delay unit 632 delays the input predicted displacement Xp(n) by Td, and outputs the displacement as the delayed predicted displacement Xp(n-Td) to the speaker displacement error calibration unit 633. Here, Td corresponds to the delay until the displacement Xs corresponding to the predicted displacement Xp(n) is detected by the displacement detection unit 7.

The speaker displacement error calibration unit 633 performs the speaker displacement error calibration process by using the predicted displacement Xp(n) input from the speaker displacement prediction unit 631, the delayed predicted displacement Xp(n−Td) input from the delay unit 632, and the displacement Xs(n) input from the displacement detection unit 7, corrects the error of the predicted displacement Xp(n), and outputs the displacement as the calibrated predicted displacement X(n) to the attenuator gain calculation unit 634.

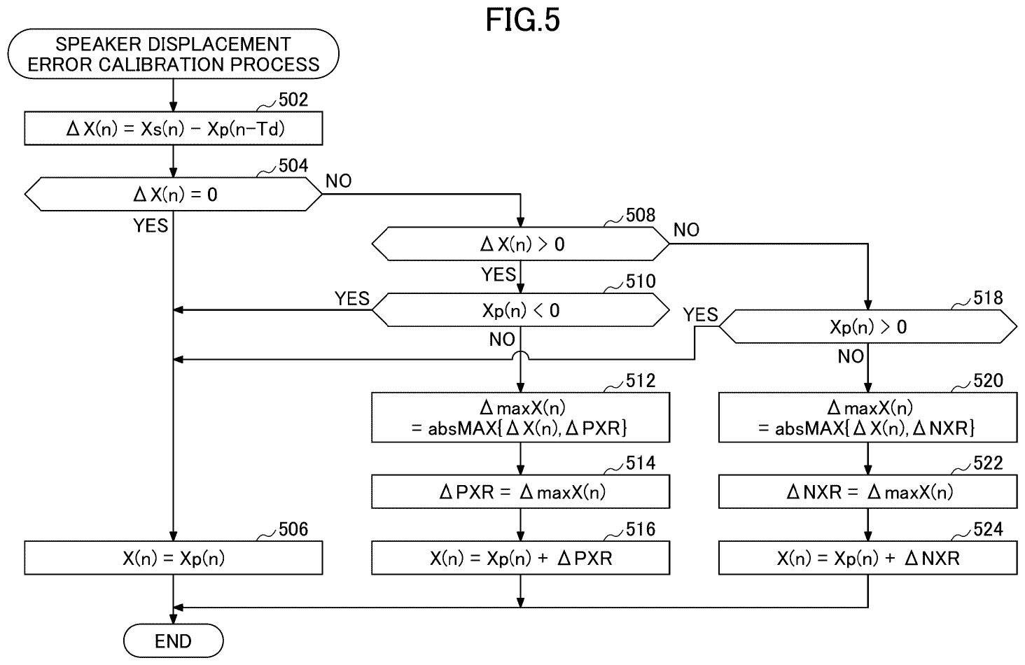

FIG. 5 illustrates the procedure of the speaker displacement error calibration process performed by the speaker displacement error calibration unit 633. Here, the speaker displacement error calibration process is repeatedly executed continuously or intermittently.

As illustrated in the figure, in this process, the prediction error ΔX(n) is first calculated by Xs(n)−Xp(n−Td) (step 502).

Then, whether or not the prediction error ΔX(n) is 0 is checked (step 504), and if it is 0, the measured displacement Xp(n) is directly output as the post-calibration predicted displacement X(n) to the attenuator gain calculation unit 634 (step 506), and the speaker displacement error calibration process of the present time is terminated.

On the other hand, when it is determined in step 504 that the prediction error ΔX(n) is not 0, it is determined whether or not the prediction error ΔX(n) is greater than 0 (step 508), and when it is greater, it is further determined whether or not Xp(n) is less than 0 (step 510), and when it is less than 0, the measured displacement Xp(n) is output as it is to the attenuator gain calculation unit 634 as the post-calibration predicted displacement X(n) (step 506), and the present speaker displacement error calibration processing is ended.

On the other hand, if it is determined in step 510 that Xp(n) is not less than 0, the function, which outputs “a” when the absolute value of the value of “a” is greater than or equal to the absolute value of the value of “b” and outputs “b” in other cases, is set to absMAX(a, b), and ΔmaxX(n) is obtained by ΔmaxX(n)=absMAX {ΔX(n), ΔPXR} (step 512). Therefore, if the absolute value of ΔX(n) is greater than or equal to the absolute value of ΔPXR, ΔmaxX(n)=ΔX(n) is satisfied, and if the absolute value of ΔX(n) is less than the absolute value of ΔPXR, ΔmaxX(n)=ΔPXR is satisfied.

The initial value of ΔPXR is set to 0.

Then, ΔPXR is updated to ΔmaxX(n) (step 514).

Further, the post-calibration predicted displacement X(n) is calculated by X(n)=Xp(n)+ΔPXR and output to the attenuator gain calculation unit 634 (step 516), thereby ending the present speaker displacement error calibration process.

On the other hand, if it is determined in step 508 that the predicted error ΔX(n) is not greater than 0, that is, if the predicted error ΔX(n) is less than 0, it is further checked whether Xp(n) is greater than 0 (step 518), and if it is greater than 0, the measured displacement Xp(n) is directly output as the post-calibration predicted displacement X(n) to the attenuator gain calculation unit 634 (step 506), thereby ending the present speaker displacement error calibration process.

On the other hand, if it is determined in step 518 that Xp(n) is not greater than 0, ΔmaxX(n) is calculated by ΔmaxX(n)=absMAX {\X(n), ΔNXR} (step 520).

The initial value of ΔNXR is set to 0.

Then, ΔNXR is updated to ΔmaxX(n) (step 522).

Further, the post-calibration predicted displacement X(n) is calculated by X(n)=Xp(n)+ΔNXR, and is output to the attenuator gain calculation unit 634 (step 524), thereby ending the present speaker displacement error calibration process.

The speaker displacement error calibration process performed by the speaker displacement error calibration unit 633 has been described above.

Here, ΔPXR and ΔNXR set in steps 514 and 522 of the above-described speaker displacement error calibration process represent values at which the absolute values of the positive and negative errors of the predicted displacement Xp with respect to the displacement Xs during the previous period, become maximum.

Therefore, the post-calibration predicted displacement X(n) calculated in steps 516 and 524 is the predicted displacement Xp(n) corrected by the past maximum error.

The reason why the update of ΔPXR/ΔNXR and the correction of the predicted displacement Xp(n) using ΔPXR/ΔNXR are not performed when the prediction error ΔX(n) is greater than 0 and Xp(n) is less than 0 (steps 508 and 510) or when the prediction error ΔX(n) is less than 0 and Xp(n) is greater than 0 (steps 508 and 518), is because in these cases, even if the correction using ΔPXR/ΔNXR is performed, the absolute value of the post-calibration predicted displacement X(n) becomes smaller than the absolute values of the predicted displacement X(n) and the prediction error ΔX(n), and therefore it is not appropriate to consider the prediction error ΔX(n) in the correction of the predicted displacement X(n) for preventing the overamplitude.

In the speaker displacement error calibration process described above, if it is determined in step 504 that the prediction error ΔX(n) is 0, instead of step 506, the process of calculating the larger absolute value of X(n)=Xp(n)+ΔPXR and X(n)=Xp(n)+ΔNXR as the post-calibration predicted displacement X(n) and outputting post-calibration predicted displacement X(n) to the attenuator gain calculation unit 634 may be performed.

Referring back to FIG. 3, the attenuator gain initial value setting unit 635 sets an initial value (for example, 0 dB) of the attenuator gain to the attenuator gain calculation unit 634 in accordance with the control of the control unit 1.

Here, the control unit 1 causes the attenuator gain initial value setting unit 635 to set an initial value of the attenuator gain when the audio system is initialized, when the audio system is started, when the output level (volume) of the sound source device 5 decreases, or when there is a change in the content being played back by the sound source device 5.

Next, the attenuator gain calculation unit 634 calculates the attenuator gain G, and when the attenuator gain G changes, sets, to the attenuator 62, the attenuator gain G after the change as the gain of the attenuator 62.

Here, as described above, the attenuator 62 adjusts the level of the audio signal output by the all-pass filter 61 with the gain set from the attenuator gain control, and outputs the signal to the amplifier 4 as an intermediate output signal.

The attenuator gain calculation unit 634 calculates the attenuator gain G as follows.

That is, the target displacement TrgX is set in advance in the attenuator gain calculation unit 634. The target displacement TrgX is the maximum value of the absolute value of the displacement allowed for the vibration system of the speaker 2, and when, for example, a displacement between +1.0 mm and −1.0 mm is allowed for the vibration system of the speaker 2, 1.0 mm is set as the target displacement TrgX.

When the initial value of the attenuator gain is set by the attenuator gain initial value setting unit 635, the attenuator gain calculating unit 634 sets the attenuator gain G to the set initial value.

Thereafter, the post-calibration predicted displacement X(n) output from the speaker displacement error calibrating unit 633 is compared with the target displacement TrgX, and when the absolute value of the post-calibration predicted displacement X(n) is greater than the target displacement TrgX, TrgX/|X(n)|, which is the ratio of the target displacement TrgX to the absolute value of the post-calibration predicted displacement X(n), is obtained.

If the gain represented by TrgX/|X(n)| is less than the current attenuator gain G (if the gain makes the attenuation larger), the attenuator gain G is updated to the gain represented by Trgx/|X(n)|.

In such calibration of the attenuator gain control unit 63, the delay time of the all-pass filter 61 in FIG. 1 described above is a delay time from the output of the predicted displacement Xp(n) from the speaker displacement predicting unit 631 to the time when the attenuator gain calculating unit 634 updates the attenuator gain G in response to the post-calibration predicted displacement X(n) output from the speaker displacement error calibrating unit 633 and sets the attenuator gain G in the attenuator 62, and the delay time is predominantly the time required to calculate the predicted displacement Xp(n) in the speaker displacement predicting unit 631.

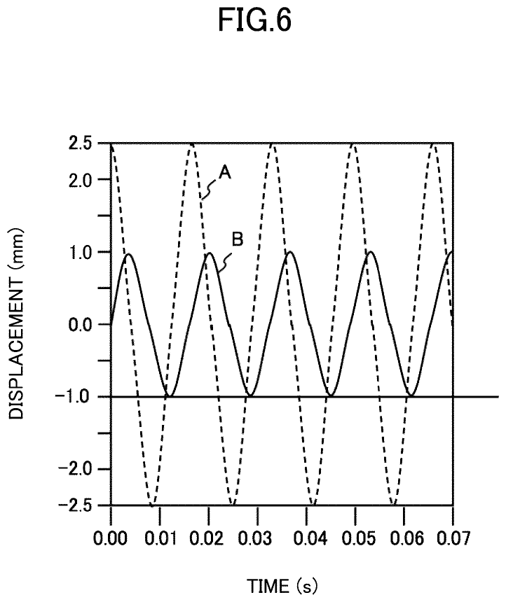

FIG. 6 illustrates an example of the simulation effect of the above-described amplitude control applied by the amplitude control unit 6.

In the illustrated example, the target displacement TrgX is set to 1.0 mm, and if the vibration system of the speaker 2 vibrates between +2.5 mm and −2.5 m as indicated by the line A when the sound source output signal S output by the sound source device 5 without amplitude control is directly output to the amplifier 4, and the amplitude control of the first embodiment is performed on the same sound source output signal S, the displacement range of the vibration of the vibration system of the speaker 2 can be set to between +1.0 mm and −1.0 m as indicated by the line B.

Note that the delay of vibration when amplitude control is performed (line B) relative to when amplitude control is not performed (line A) is caused by the delay of the all-pass filter 61.

The first embodiment of the present invention has been described above.

Although the speaker displacement error calibration processing in the first embodiment may be repeatedly performed continuously or intermittently over the entire period during the operation of the acoustic system, the speaker displacement error calibration processing may be performed repeatedly only during a predetermined period such as when the acoustic system is initialized, when the acoustic system is started, when the output level (volume) of the sound source device 5 changes, or during an interval (for example, if the content is a song, between songs) between the reproduction of the contents by the sound source device 5.

However, when the speaker displacement error calibration processing is performed only during a predetermined period, the speaker displacement error calibration unit 633 performs the error-fixed speaker displacement error calibration processing after the lapse of the predetermined period. In the error-fixed speaker displacement error calibration processing, steps 512, 514, 520, and 522 of the speaker displacement error calibration processing illustrated in FIG. 5 are skipped, and ΔPXR and ΔNXR used in steps 516 and 524 are fixed to ΔPXR and ΔNXR finally obtained by the speaker displacement error calibration processing performed during the predetermined period.

As described above, according to the first embodiment, the error of the displacement predicted at a current time is estimated based on the actual result of the difference between the displacement predicted by the speaker displacement prediction unit 631 from the sound source output signal S in the past and the displacement actually detected by the displacement detection unit 7 with respect to the sound source output signal S, the predicted displacement is corrected by the error, and the amplitude control based on the corrected displacement is performed, so that the amplitude of the vibration system of the speaker 2 can be controlled to a target amplitude range more accurately than when the amplitude control is performed based only on the displacement predicted by the speaker displacement prediction unit 631.

The second embodiment of the present invention will be described below.

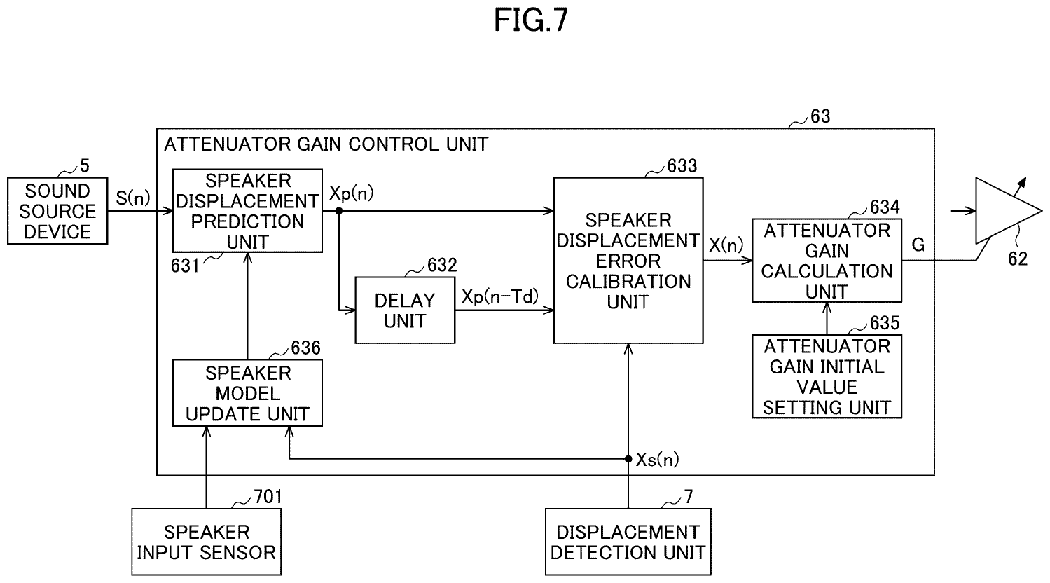

The second embodiment differs from the first embodiment in that, as illustrated in FIG. 7, a speaker input sensor 701 is provided for detecting a current flowing through the speaker 2, an input voltage of the speaker 2, and the like, and the attenuator gain control unit 63 is configured as illustrated in FIG. 7.

As illustrated in FIG. 7, in the attenuator gain control unit 63 of the second embodiment, the attenuator gain control unit 63 of the first embodiment illustrated in FIG. 3 is provided with a speaker model update unit 636 for updating the characteristics of an equivalent circuit used for predicting the displacement of the vibration system by the speaker displacement prediction unit 631.

When the acoustic system is initialized, when the acoustic system is started, when the output level (volume) of the sound source device 5 is changed, or between the reproduction of contents of the sound source device 5 (for example, if the content are songs, between songs), the control unit 1 causes the sound source device 5 to output an appropriate output signal, such as a test signal, a music signal, and an acoustic watermark signal, as a sound source output signal, while controlling the all pass filter of the amplitude control unit 6 and the attenuator 62 to output the input signal as it is, and causes the speaker model update unit 636 to perform an update operation of the equivalent circuit.

In the update operation, the speaker model update unit 636 obtains the characteristics of the equivalent circuit consistent with the behavior of the speaker 2 from measured values such as the current flowing through the speaker 2 and the input voltage of the speaker 2 detected by the speaker input sensor 701, and the displacement Xs detected by the displacement detection unit 7, and updates the characteristics of the equivalent circuit used for predicting the displacement of the vibration system by the speaker displacement prediction unit 631 to the obtained characteristics.

For example, when the characteristic of the equivalent circuit to be obtained is Kₘₛ(x); Stiffness of the equivalent circuit of the speaker 2 illustrated in FIG. 4, the speaker model update unit 636 can perform a calculation based on the measured values as follows.

That is, the resonance frequency fs of the impedance Z=u/i of the speaker 2 is detected from the current i flowing through the speaker 2 and the input voltage u of the speaker 2. Then, by using Mₘₛ; Mechanical mass,

Kₘₛ(x)=(2πfs)²Mₘₛ

is calculated, the relationship between the displacement Xs of the vibration system of the speaker 2 output from the sensor 3 and Kₘₛ(Xs) is obtained, and the nonlinear characteristic of Kₘₛ(Xs) is calculated according to the obtained relationship.

Here, the nonlinear characteristics of Kₘₛ(Xs) may be calculated by preparing a plurality of patterns of the nonlinear characteristics of Kₘₛ(Xs) in advance, and calculating a pattern matching the relationship between the obtained displacement x and Kₘₛ(Xs) as the nonlinear characteristics of Kₘₛ(Xs).

According to such an acoustic system, the characteristics of the equivalent circuit used by the speaker displacement prediction unit 631 for predicting the displacement of the vibration system can be updated at any time by using the actual displacement of the vibration system of the speaker 2 detected by the displacement detection unit 7 so as to be well consistent with the actual characteristics of the speaker 2.

A third embodiment of the present invention will be described below.

The third embodiment differs from the second embodiment only in the configuration of the attenuator gain control unit 63.

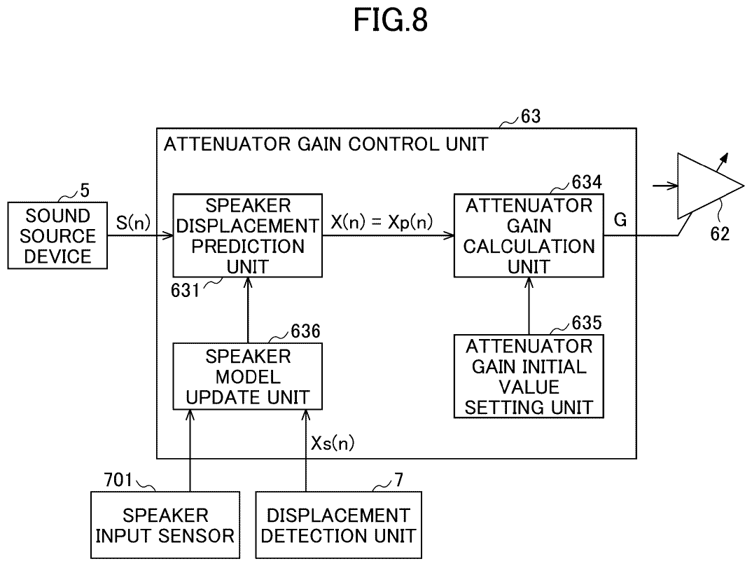

FIG. 8 illustrates the configuration of the attenuator gain control unit 63 of the third embodiment.

As illustrated in the figure, in the attenuator gain control unit 63 of the third embodiment, the delay unit 632 and the speaker displacement error calibration unit 633 are eliminated from the attenuator gain control unit 63 of the second embodiment illustrated in FIG. 7, and the predicted displacement Xp(n) calculated by the speaker displacement prediction unit 631 is output to the attenuator gain calculation unit 634.

In the third embodiment, the attenuator gain calculation unit 634 calculates the attenuator gain G described in the first embodiment by using the predicted displacement Xp(n) instead of the post-calibration predicted displacement X(n).

According to such an acoustic system, the characteristics of the equivalent circuit used by the speaker displacement prediction unit 631 for predicting the displacement of the vibration system can be updated at any time by using the actual displacement of the vibration system of the speaker 2 detected by the displacement detection unit 7 so as to be consistent with the characteristics of the actual speaker 2. As a result, the accuracy of the prediction of the displacement can be improved compared with the case where the characteristics of the equivalent circuit using the actual displacement of the vibration system of the speaker 2 are not updated, and the amplitude of the vibration system of the speaker 2 can be more accurately controlled to be within a target amplitude range.

A fourth embodiment of the present invention will be described below.

The fourth embodiment of the present invention differs from the first embodiment in the configuration of the amplitude control unit 6.

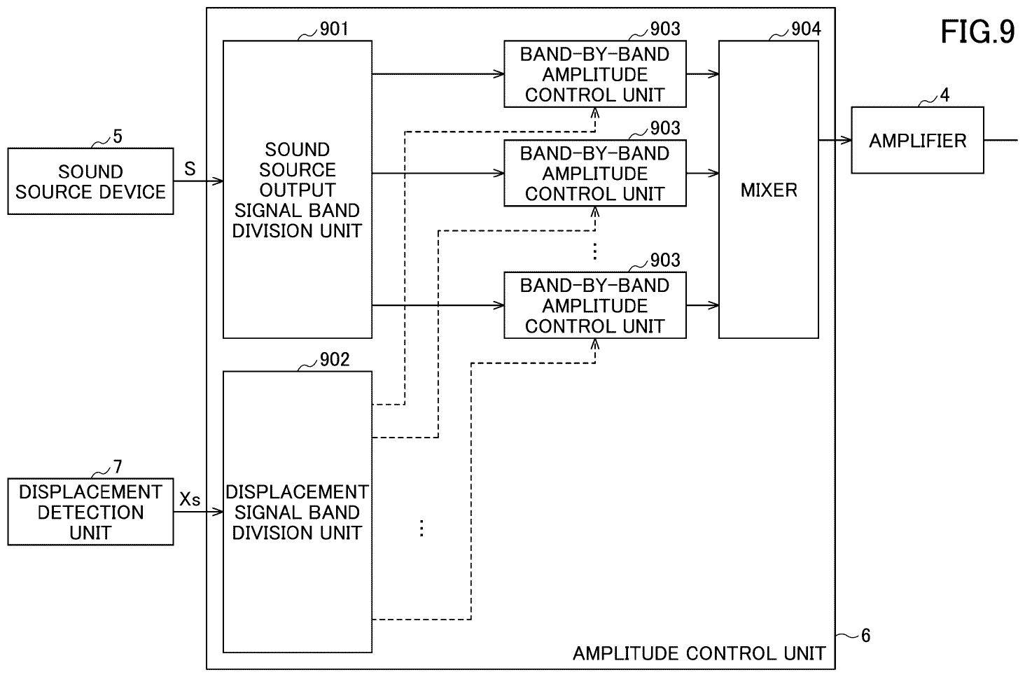

FIG. 9 illustrates the configuration of the amplitude control unit 6 of the fourth embodiment.

As illustrated in the figure, the amplitude control unit 6 of the fourth embodiment includes a sound source output signal band division unit 901, a displacement signal band division unit 902, a plurality of band-by-band amplitude control units 903, and a mixer 904.

All of the band-by-band amplitude control units 903 have the same configuration and perform the same processing as any of the amplitude control units 6 of the first, second, and third embodiments.

Each band-by-band amplitude control unit 903 is provided for each of a plurality of bands obtained by dividing the entire band of the sound source output signal S, and the sound source output signal band division unit 901 divides the sound source output signal S output from the sound source device 5 into bands and outputs the sound source output signal S of each band to the band-by-band amplitude control unit 903 corresponding to the band, and the displacement signal band division unit 902 divides the displacement signal Xs output from the displacement detection unit 7 into bands and outputs the displacement signal Xs of each band to the band-by-band amplitude control unit 903 corresponding to the band.

The signals output by each band-by-band amplitude control unit 903 after performing the above processing on the sound source output signal S and the displacement signal Xs of the corresponding band, are input to the mixer 904.

The mixer 904 combines the signals input from each band-by-band amplitude control unit 903 and outputs the signals to the amplifier 4 as intermediate output signals.

By using the amplitude control unit 6 as illustrated in FIG. 9 to perform amplitude control for each band, it is possible to prevent over-vibration and prevent a decrease in the level of the speaker output as a whole.

A fifth embodiment of the present invention will be described below.

The fifth embodiment of the present invention differs from the first embodiment in the configuration of the amplitude control unit 6.

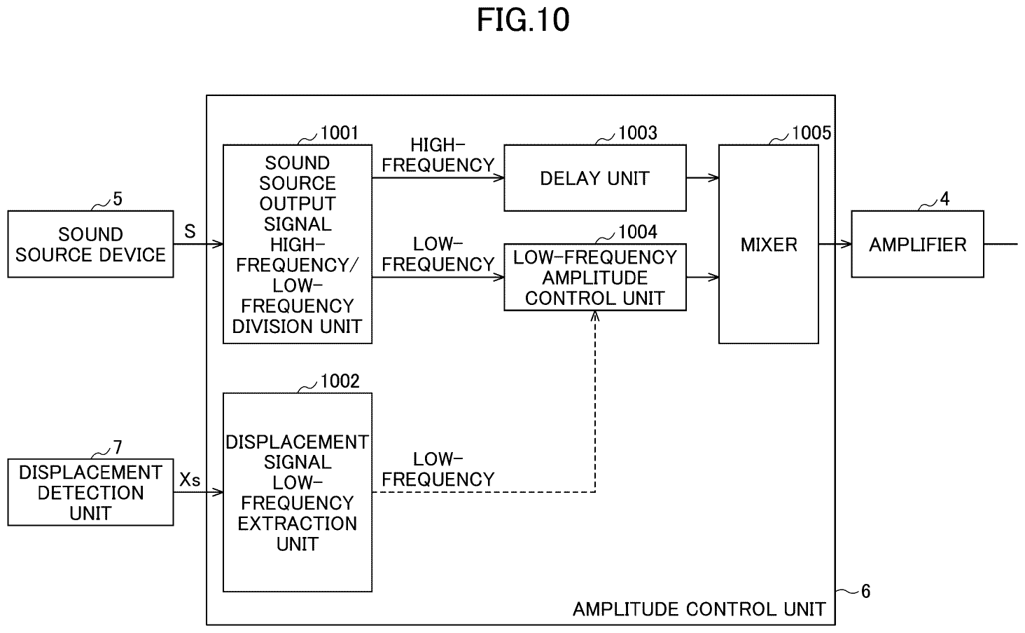

FIG. 10 illustrates the configuration of the amplitude control unit 6 of the fifth embodiment.

As illustrated in the figure, the amplitude control unit 6 of the fifth embodiment includes a sound source output signal high-frequency/low-frequency division unit 1001, a displacement signal low-frequency extraction unit 1002, a delay unit 1003, a low-frequency amplitude control unit 1004, and a mixer 1005.

The sound source output signal high-frequency/low-frequency division unit 1001 divides the sound source output signal S output from the sound source device 5 into high-frequency components and low-frequency components, outputs the high-frequency component to the delay unit 1003, and outputs the low-frequency component to the low-frequency amplitude control unit 1004.

The displacement signal low-frequency extraction unit 1002 extracts a low-frequency component of the displacement signal Xs output by the displacement detection unit 7, and outputs the low-frequency component to the low-frequency amplitude control unit 1004.

The low-frequency amplitude control unit 1004 has the same configuration and performs the same processing as any of the amplitude control units 6 of the first, second, and third embodiments.

The low-frequency amplitude control unit 1004 performs the above processing on the low-frequency sound source output signal S and the displacement signal Xs, and outputs the signals to the mixer 904.

The delay unit 1003 delays the high-frequency component signal of the input sound source output signal S by the delay of the processing in the low-frequency amplitude control unit 1004, and outputs the signal to the mixer 904.

The mixer 904 combines the signals input from the delay unit 1003 and the low-frequency amplitude control unit 1004, and outputs the combined signal to the amplifier 4 as an intermediate output signal.

Because the large displacement of the vibration system of the speaker 2 is caused by approximately the low-frequency component, by using the amplitude control unit 6 illustrated in FIG. 10 to perform amplitude control only on the low-frequency side, it is possible to mitigate the decrease in the level of the speaker output as a whole while effectively preventing the vibration.

As such a configuration for performing amplitude control only on the low-frequency side, it is also possible to use a configuration in which a plurality of band-by-band amplitude control units 903 corresponding to a plurality of bands on the low-frequency side are left in the amplitude control apparatus illustrated in FIG. 9, and the band-by-band amplitude control unit 903 corresponding to a band on the high-frequency side is replaced with the delay unit 1003.

The embodiments of the present invention have been described above.

What is claimed is:

1. An overamplitude prevention apparatus of a speaker for preventing overamplitude of a vibration system of the speaker with respect to an input signal, the overamplitude prevention apparatus comprising:
a displacement detector configured to detect a displacement of the vibration system of the speaker; and
an amplitude controller to which the input signal is input, wherein
the amplitude controller includes:
a gain adjuster configured to adjust the input signal by a set gain and output the input signal to the speaker;
a displacement predictor configured to predict the displacement of the vibration system of the speaker based on the input signal;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width, wherein
the predicted displacement corrector calculates a difference of the displacement predicted by the displacement predictor in the past with respect to the displacement detected by the displacement detector corresponding to the input signal used for predicting the displacement, and corrects the displacement predicted by the displacement predictor by an amount according to the calculated difference.

2. An overamplitude prevention apparatus of a speaker for preventing overamplitude of a vibration system of the speaker with respect to an input signal, the overamplitude prevention apparatus comprising:
a displacement detector configured to detect a displacement of the vibration system of the speaker;
a band divider configured to divide the input signal into input signals of respective bands;
an amplitude controller to which the input signal is input, the input signal being of a corresponding band obtained by the division by the band divider, the amplitude controller being provided corresponding to each of the bands; and
a mixer, wherein
each of the amplitude controllers includes:
a gain adjuster configured to adjust the input signal of the corresponding band by a set gain and output the input signal to the mixer;
a displacement predictor configured to predict the displacement of the vibration system of the speaker based on the input signal of the corresponding band;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width, wherein
the predicted displacement corrector calculates a difference between the displacement predicted by the displacement predictor in the past and a component of the corresponding band of the displacement detected by the displacement detector corresponding to the input signal of the corresponding band used for predicting the displacement, and corrects the displacement predicted by the displacement predictor by an amount according to the calculated difference, and
the mixer combines the input signals of the respective bands output from the gain adjuster of each of the amplitude controllers, and outputs the combined signal to the speaker.

3. An overamplitude prevention apparatus of a speaker for preventing overamplitude of a vibration system of the speaker with respect to an input signal, the overamplitude prevention apparatus comprising:
a displacement detector configured to detect a displacement of the vibration system of the speaker;
a band divider configured to divide the input signal into an input signal of a low-frequency side and an input signal of a high-frequency side;
an amplitude controller to which the input signal is input, the input signal being of the low-frequency side obtained by the division by the band divider; and
a mixer, wherein
the amplitude controller includes:
a gain adjuster configured to adjust the input signal of the low-frequency side by a set gain and output the input signal to the mixer;
a displacement predictor configured to predict the displacement of the vibration system of the speaker based on the input signal of the low-frequency side;
a predicted displacement corrector configured to correct the displacement predicted by the displacement predictor; and
a gain setter configured to set the gain in the gain adjuster, the gain being for attenuating the displacement corrected by the predicted displacement corrector to a displacement not exceeding a predetermined displacement width, wherein
the predicted displacement corrector calculates a difference between the displacement predicted by the displacement predictor in the past and a component of the low-frequency side of the displacement detected by the displacement detector corresponding to the input signal of the low-frequency side used for predicting the displacement, and corrects the displacement predicted by the displacement predictor by an amount according to the calculated difference, and
the mixer combines the input signal of the low-frequency side output from the gain adjuster of the amplitude controller with the input signal of the high-frequency side obtained by the division by the band divider, and outputs the combined signal to the speaker.

4. The overamplitude prevention apparatus of the speaker according to claim 1, wherein the predicted displacement corrector corrects the displacement predicted by the displacement predictor by a maximum value of the difference calculated until a current time.

5. The overamplitude prevention apparatus of the speaker according to claim 1, wherein the gain setter sets, to the gain adjuster, a gain for attenuating the displacement corrected by the predicted displacement corrector to a displacement not exceeding a predetermined displacement width, when the gain for attenuating the displacement to the displacement not exceeding the predetermined displacement width is smaller than the gain currently set in the gain adjuster.

6. The overamplitude prevention apparatus of the speaker according to claim 1, further comprising:
an input detector configured to detect an input of the speaker; and
a speaker equivalent circuit updater, wherein
the displacement predictor predicts the displacement of the vibration system of the speaker according to an equivalent circuit of the speaker set in the displacement predictor, and
the speaker equivalent circuit updater updates a characteristic of the equivalent circuit set in the displacement predictor so as to be consistent with a relationship between the input of the speaker detected by the input detector and the displacement detected with respect to the input by the displacement detector.

7. An overamplitude prevention apparatus of a speaker for preventing overamplitude of a vibration system of the speaker with respect to an input signal, the overamplitude prevention apparatus comprising:
a displacement detector configured to detect a displacement of the vibration system of the speaker;
an input detector configured to detect an input of the speaker; and
an amplitude controller to which the input signal is input, wherein
the amplitude controller includes:
a gain adjuster configured to adjust the input signal by a set gain and output the input signal to the speaker;
a displacement predictor configured to predict the displacement of the vibration system of the speaker based on the input signal according to an equivalent circuit of the speaker set in the displacement predictor;
a gain setter configured to set the gain in the gain adjuster, the gain being for attenuating the displacement to a displacement not exceeding a predetermined displacement width; and
a speaker equivalent circuit updater configured to update a characteristic of the equivalent circuit set in the displacement predictor so as to be consistent with a relationship between the input of the speaker detected by the input detector and the displacement detected with respect to the input by the displacement detector.
